(19) United States
(12) Patent Application Publication
(10) Pub. No.: US 2019/0351851 A1
(43) Pub. Date: Nov. 21, 2019

(54) ONBOARD CONTROL DEVICE AND ONBOARD POWER SUPPLY DEVICE

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-Shi, Osaka (JP)

(72) Inventor: Takeshi Hasegawa, Yokkaichi, Mie (JP)

(21) Appl. No.: 16/476,631

(22) PCT Filed: Jan. 8, 2018
(86) PCT No.: PCT/JP2018/000140

§ 371 Date: Jul. 9, 2019

(30) Foreign Application Priority Data
Jan. 19, 2017 (JP) 2017-007583

(51) Int. Cl. B60R 16/03; H02J 9/06

(52) U.S. Cl. CPC B60R 16/03; H02J 9/06

(57) ABSTRACT

In an onboard control device, a power source failure detection unit detects a predetermined failure state of power supply from a first power source unit. A processing speed determination unit sets a processing speed to a suppressed speed when the failure state is detected by the power source failure detection unit, and sets the processing speed to a speed higher than the suppressed speed when a trigger signal is externally generated while the processing speed is set to the suppressed speed. A control unit operates at a processing speed determined by the processing speed determination unit, and performs feedback control by calculating a duty ratio of a PWM signal to be given to a voltage conversion unit based on a preset target value and an output value from the voltage conversion unit, and outputting a PWM signal set to the calculated duty ratio to the voltage conversion unit.

### CROSS-REFERENCE TO RELATED APPLICATIONS

This application is the U.S. national stage of PCT/JP2018/000140 filed on Jan. 8, 2018, which claims priority of Japanese Patent Application No. JP 2017-007583 filed on Jan. 19, 2017, the contents of which are incorporated herein.

### TECHNICAL FIELD

The present disclosure relates to an onboard control device and an onboard power supply device.

### BACKGROUND

A known vehicle power supply system includes an auxiliary power source so that the power supply system can continue supplying power when a failure occurs in a main power source. For example, a power supply system disclosed in Patent Document 1 includes a main battery and a sub battery and is capable of, upon occurrence of a failure in the main battery, switching an electrical path between the main battery and an important load to an electrically disconnected state by controlling a switching unit, and supplying power from the sub battery.

In a power supply system that uses a first power source unit, which can serve as a main power source, and a second power source unit, which can serve as an auxiliary power source, it is necessary that, upon occurrence of a failure in the first power source unit, sufficient power is supplied from the second power source unit to a load, which is a backup target, at a time when the power is necessary. However, when a failure has occurred in the first power source unit and only the second power source unit is available, the amount of consumable power is severely limited, and if a large amount of power of the second power source unit is consumed when not that much power is required, it may be impossible to supply sufficient power from the second power source unit when the load as the backup target needs to reliably operate. This problem is particularly noticeable when the cost and size of the second power source unit are reduced.

The present disclosure was made under the above-described circumstances, and its object is to provide an onboard control device or an onboard power supply device that is capable of suppressing the consumption of power of a second power source unit upon occurrence of a failure in a first power source unit, and thereafter increasing power supply from the second power source unit under predetermined conditions.

### SUMMARY

An onboard control device according to a first aspect of the present disclosure is an onboard control device in an onboard power supply system that includes a first power source unit, a second power source unit, and a voltage conversion unit that is capable of performing a discharging operation of stepping up or stepping down an input voltage based on power supply from the second power source unit and outputting a resultant voltage through an on/off operation of a switching element according to a PWM signal, the onboard power supply system being capable of charging the second power source unit using power supplied from the first power source unit or a generator, the onboard control device being configured to control the discharging operation of the voltage conversion unit. The onboard control device includes a power source failure detection unit that detects a predetermined failure state of power supply from the first power source unit. A processing speed determination unit sets a processing speed to a predetermined suppressed speed at least when the failure state is detected by the power source failure detection unit, and sets the processing speed to a speed higher than the suppressed speed when a trigger signal is externally generated while the processing speed is set to the suppressed speed. A control unit is configured to operate at a processing speed determined by the processing speed determination unit, and performs feedback control by calculating a duty ratio of a PWM signal to be given to the voltage conversion unit based on a preset target value and an output value from the voltage conversion unit, and outputting a PWM signal set to the calculated duty ratio to the voltage conversion unit.

An onboard power supply device according to a second aspect of the present disclosure includes the above-described onboard control device and the above-described voltage conversion unit.

### Advantageous Effects of Disclosure

In the onboard control device of the first aspect, the processing speed determination unit sets the processing speed to a relatively low suppressed speed at least when the failure state of the first power source unit is detected by the power source failure detection unit. Further, the control unit performs feedback control on the voltage conversion unit while operating at the processing speed determined by the processing speed determination unit. As described above, after the occurrence of a failure in the first power source unit, the control unit operates at the suppressed processing speed and therefore the consumption of power supplied from the second power source unit can be suppressed. On the other hand, if a trigger signal is externally generated while the processing speed is set to the suppressed speed, the processing speed determination unit sets the processing speed to a speed higher than the suppressed speed. As described above, if the trigger signal is externally generated, the processing speed is switched to enable the control unit to operate at a relatively high processing speed. Thus, once the trigger signal is generated, restrictions are alleviated and the power supply can be increased.

The onboard power supply device of the second aspect of the present disclosure achieves effects similar to those achieved by the onboard control device of the first aspect.

### BRIEF DESCRIPTION OF DRAWINGS

FIG. 1 is a block diagram schematically illustrating a power supply system that includes an onboard control device of a first embodiment.

FIG. 2 is a flowchart illustrating an example of the flow of control that is performed on a wakeup signal and a calculation-speed change request signal by a processing speed determination unit of the onboard control device of the first embodiment.

FIG. 3 is a flowchart illustrating an example of the flow of feedback control that is performed by a control unit of the onboard control device of the first embodiment.

FIG. 4 is a timing chart schematically illustrating an example of changes in an output current in the onboard control device of the first embodiment and an example of changes in the wakeup signal, the calculation-speed change request signal, a processing speed of a microcomputer, and the state of the microcomputer according to the output current.

FIG. 5 is a block diagram illustrating a specific example of a power supply system to which the onboard control device of the first embodiment is applied.

FIG. 6 is a flowchart illustrating an example of the flow of control in a case where the onboard control device of the first embodiment is applied to the power supply system of FIG. 5.

### DETAILED DESCRIPTION OF PREFERRED EMBODIMENTS

The following describes preferable examples of the present disclosure.

The trigger signal may be a signal that indicates that the speed of a vehicle in which the onboard control device is installed is equal to or lower than a predetermined speed. The processing speed determination unit may set the processing speed to a speed higher than the suppressed speed when the signal indicating that the speed of the vehicle is equal to or lower than the predetermined speed is externally generated while the processing speed is set to the suppressed speed.

The onboard control device configured as described above is capable of immediately suppressing power consumption upon the occurrence of a failure in the first power source unit, and thereafter increasing the power supply by alleviating restrictions when the speed of the vehicle becomes equal to or lower than the predetermined speed. That is, the consumption of power of the second power source unit is restricted until the speed of the vehicle becomes equal to or lower than the predetermined speed, and therefore the power of the second power source unit can be easily secured after the speed of the vehicle becomes equal to or lower than the predetermined speed. This makes it easier for apparatuses to properly perform operations that are to be performed when the speed of the vehicle is equal to or lower than the predetermined speed (for example, a shift operation to the P range or an operation of an electric parking brake).

The trigger signal may be a signal that indicates that a predetermined shift operation has been performed by a user. The processing speed determination unit may set the processing speed to a speed higher than the suppressed speed when the signal indicating that the predetermined shift operation has been performed is externally generated while the processing speed is set to the suppressed speed.

The onboard control device configured as described above is capable of immediately suppressing power consumption upon the occurrence of a failure in the first power source unit, and thereafter increasing the power supply by alleviating restrictions when the predetermined shift operation is performed. That is, the consumption of power of the second power source unit is restricted until the predetermined shift operation is performed, and therefore the power of the second power source unit can be easily secured when the predetermined shift operation is performed. This makes it easier for apparatuses to properly perform operations that are to be performed after the predetermined shift operation (for example, an operation of an actuator for shift switching or an operation of the electric parking brake).

### First Embodiment

The following describes a first embodiment as a specific embodiment of the present disclosure.

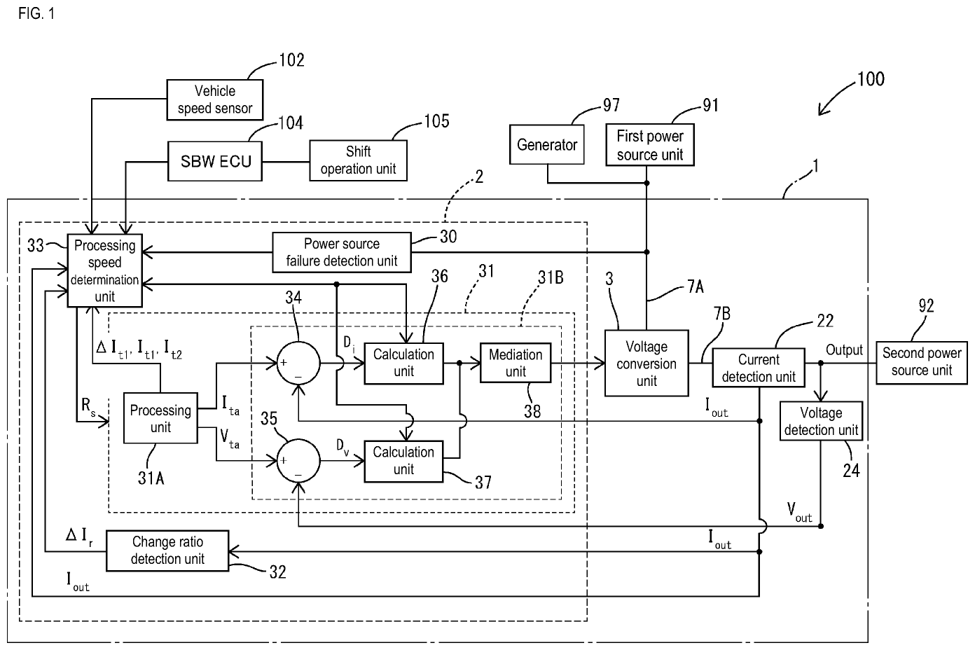

FIG. 1 is a block diagram schematically illustrating an onboard power supply system 100 (hereinafter also referred to as a power supply system 100) that includes an onboard power supply device 1 of the first embodiment. The power supply system 100 is a system that includes a first power source unit 91, a second power source unit 92, a generator 97, the onboard power supply device 1, and the like, and is capable of supplying power to various electrical parts. The onboard power supply device 1 (hereinafter also referred to as a power supply device 1) is a power supply device that is capable of receiving power supplied from onboard power source units (the first power source unit 91 and the second power source unit 92) and generating a desired output voltage. The power supply device 1 includes an onboard control device 2 (hereinafter also referred to as a control device 2), a voltage conversion unit 3, a current detection unit 22, a voltage detection unit 24, and the like, and has a function of outputting, to an output-side conductive path 7B, an output voltage that is obtained by stepping down or stepping up a direct current voltage (input voltage) applied to an input-side conductive path 7A.

The input-side conductive path 7A is configured as a primary-side power line to which a direct current voltage is applied by the first power source unit 91, and is electrically connected to a high potential-side terminal of the first power source unit 91. The first power source unit 91 is constituted by a known onboard battery such as a lead storage battery. As shown in FIG. 1, the generator 97, which is configured as a known alternator, a non-illustrated starter, and the like are also electrically connected to the input-side conductive path 7A to which the first power source unit 91 is connected.

The output-side conductive path 7B is configured as a secondary-side power line to which a direct current voltage is applied by the second power source unit 92, and is electrically connected to a high potential-side terminal of the second power source unit 92. The second power source unit 92 is constituted by a known onboard power storage device such as a lithium ion battery or an electric double layer capacitor.

The voltage conversion unit 3 is configured to step up or step down an input voltage applied to the input-side conductive path 7A and output the resultant voltage to the output-side conductive path 7B through an on/off operation of a switching element (for example, MOSFET) according to a PWM signal, and is configured as a synchronous rectifying type DCDC converter or a diode type DCDC converter, for example. The voltage conversion unit 3 may be, for example, a step-up converter that steps up the input voltage applied to the input-side conductive path 7A through an on/off operation of the switching element, which is controlled by the PWM signal, and outputs the resultant voltage to the output-side conductive path 7B, or a step-down converter that steps down the input voltage applied to the input-side conductive path 7A through an on/off operation of the switching element controlled by the PWM signal and outputs the resultant voltage to the output-side conductive path 7B. Alternatively, the voltage conversion unit 3 may be a step-up and step-down converter that switches between a mode (step-up mode) of stepping up the input voltage applied to the input-side conductive path 7A and outputting the resultant voltage to the output-side conductive path 7B and a mode (step-down mode) of stepping down the input voltage applied to the input-side conductive path 7A and outputting the resultant voltage to the output-side conductive path 7B. Alternatively, the voltage conversion unit 3 may be a bidirectional step-up and step-down converter that switches between a mode of stepping up or stepping down the input voltage applied to the conductive path 7A and outputting the resultant voltage to the conductive path 7B and a mode of stepping up or stepping down an input voltage applied to the conductive path 7B and outputting the resultant voltage to the conductive path 7A.

The following describes, as a representative example of these, a bidirectional step-up and step-down converter that switches between a step-down mode of stepping down an input voltage applied to the conductive path 7A and outputting the resultant voltage to the conductive path 7B and a step-up mode of stepping up an input voltage applied to the conductive path 7B and outputting the resultant voltage to the conductive path 7A, and the description referring to FIG. 1, for example, is focused on the mode (step-down mode) of stepping down the input voltage applied to the conductive path 7A and outputting the resultant voltage to the conductive path 7B. However, this is merely an example and does not limit the present disclosure.

The current detection unit 22 is capable of detecting a current flowing through the output-side conductive path 7B and outputting a value corresponding to the magnitude of a current output from the voltage conversion unit. Specifically, the current detection unit 22 is configured to output a voltage value corresponding to the current flowing through the output-side conductive path 7B as a detection value. For example, the current detection unit 22 includes a resistor and a differential amplifier that are disposed on the output-side conductive path 7B. A voltage across the resistor is input to the differential amplifier, the amount of a voltage drop that occurred in the resistor due to the current flowing through the output-side conductive path 7B is amplified by the differential amplifier, and the resultant value is output as a detection value.

The voltage detection unit 24 is capable of detecting an output voltage of the output-side conductive path 7B and outputting a value corresponding to the magnitude of the output voltage. Specifically, the voltage detection unit 24 outputs a value that reflects the voltage of the output-side conductive path 7B (for example, the voltage of the output-side conductive path 7B itself, a divided voltage value, or the like).

In the following description, a current value of the output-side conductive path 7B that is identified using a detection value output from the current detection unit 22 will be referred to as a current value Tout, and a voltage value of the output-side conductive path 7B that is identified using a detection value output from the voltage detection unit 24 will be referred to as a voltage value Vout.

As shown in FIG. 1, the control device 2 mainly includes a power source failure detection unit 30, a control unit 31, a change ratio detection unit 32, and a processing speed determination unit 33. The control unit 31 mainly includes a processing unit 31A and a drive unit 31B.

The change ratio detection unit 32 of the control device 2 has a function of detecting the change ratio of a current that is output from the voltage conversion unit 3. The change ratio detection unit 32 is capable of monitoring the current value lout output from the current detection unit 22 and calculating and outputting a current change ratio ΔIr per unit time (hereinafter referred to as a current change ratio ΔIr) of a current flowing through the output-side conductive path 7B. That is, the change ratio detection unit 32 is capable of detecting a current change ratio ΔIr of the current output from the voltage conversion unit 3.

The processing unit 31A of the control unit 31 is configured as a microcomputer, for example, and includes a CPU, a ROM, a RAM, a non-volatile memory, and the like. The processing unit 31A is a unit that processes a current change ratio threshold value ΔIt1, which is a first threshold value, a low output current threshold value It1, a high output current threshold value It2, which is a second threshold value, a target value Ita of a current output from the voltage conversion unit 3 (hereinafter referred to as a target value Ita), and a target value Vta of a voltage output from the voltage conversion unit 3 (hereinafter referred to as a target value Vta). The target values Ita and Vta are values that are preset in the processing unit 31A.

The drive unit 31B of the control unit 31 performs feedback control such that the current and voltage output from the voltage conversion unit 3 have predetermined magnitudes. Specifically, the drive unit 31B determines a control amount (hereinafter referred to as a duty ratio) by performing known PID control feedback calculation based on the current value lout and the voltage value Vout of the output-side conductive path 7B, the target value Ita, and the target value Vta. Then, the drive unit 31B outputs a PWM signal that has the determined duty ratio to the switching element of the voltage conversion unit 3.

The control unit 31 has a function of calculating the duty ratio of a PWM signal to be given to the voltage conversion unit 3 based on the preset target values (target values Ita and Vta) and output values (current value lout and voltage value Vout) from the voltage conversion unit 3, and outputting the PWM signal set to the calculated duty ratio to the voltage conversion unit 3. The control unit 31 is configured to operate at a processing speed that is determined by the processing speed determination unit 33 described below.

The processing speed determination unit 33 has a function of determining a processing speed such that the processing speed increases as the current change ratio ΔIr detected by the change ratio detection unit 32 increases. The processing speed determination unit 33 determines the processing speed based on the current value Tout identified using the detection value of the current detection unit 22, the current change ratio ΔIr detected by the change ratio detection unit 32, the current change ratio threshold value ΔIt1, the low output current threshold value It1, and the high output current threshold value It2 that are acquired by the processing unit 31A. Specifically, the processing speed determination unit 33 has a function of outputting a wakeup signal Rs and a calculation-speed change request signal Ro described below by setting each signal to a low level L or a high level H based on the current value Tout, the current change ratio ΔIr, the current change ratio threshold value ΔIt1, the low output current threshold value It1, and the high output current threshold value It2.

The wakeup signal Rs is used to switch the control unit 31 to a sleep state or a low-speed state, for example. The calculation-speed change request signal Ro is used to change the processing speed of the drive unit 31B, for example.

The processing speed determination unit 33 has a function of switching the wakeup signal Rs to the low level in response to the first power source unit 91 entering a failure state, and switching the wakeup signal Rs to the high level in response to a trigger signal being input from the outside when the wakeup signal Rs is at the low level. Details of this function will be described later.

As shown in FIG. 1, the processing speed determination unit 33 is configured to receive signals from the outside. Specifically, a vehicle speed sensor 102 that detects the speed of a vehicle (vehicle in which the power supply device 1 is installed) is provided, and vehicle speed information is given from the vehicle speed sensor 102 to the processing speed determination unit 33. Out of vehicle speed signals that are sent from the vehicle speed sensor 102 to the processing speed determination unit 33, a signal that indicates that the speed of the vehicle is equal to or lower than a predetermined speed corresponds to an example of the trigger signal.

Further, a shift-by-wire ECU 104 is provided inside the vehicle, and when a shift operation unit 105 is shifted to the P range by a user, the shift-by-wire ECU 104 gives the processing speed determination unit 33 a signal that indicates the shift operation to the P range (i.e., a signal indicating that a predetermined shift operation has been performed by the user). Out of signals that are given from the shift-by-wire ECU 104 to the processing speed determination unit 33, the signal indicating the shift operation to the P range corresponds to an example of the trigger signal.

The power source failure detection unit 30 is a unit that detects a predetermined failure state of power supply from the first power source unit 91. The power source failure detection unit 30 determines whether a voltage applied to the first conductive path 7A electrically connected to the first power source unit 91 is at least at a predetermined threshold value (threshold value for determining a power source failure), outputs a first signal (non-detection signal) if the voltage applied to the first conductive path 7A is at least at the predetermined threshold value, and outputs a second signal (failure detection signal) if the voltage applied to the first conductive path 7A is lower than the predetermined threshold value. A signal output from the power source failure detection unit 30 is given to the processing speed determination unit 33.

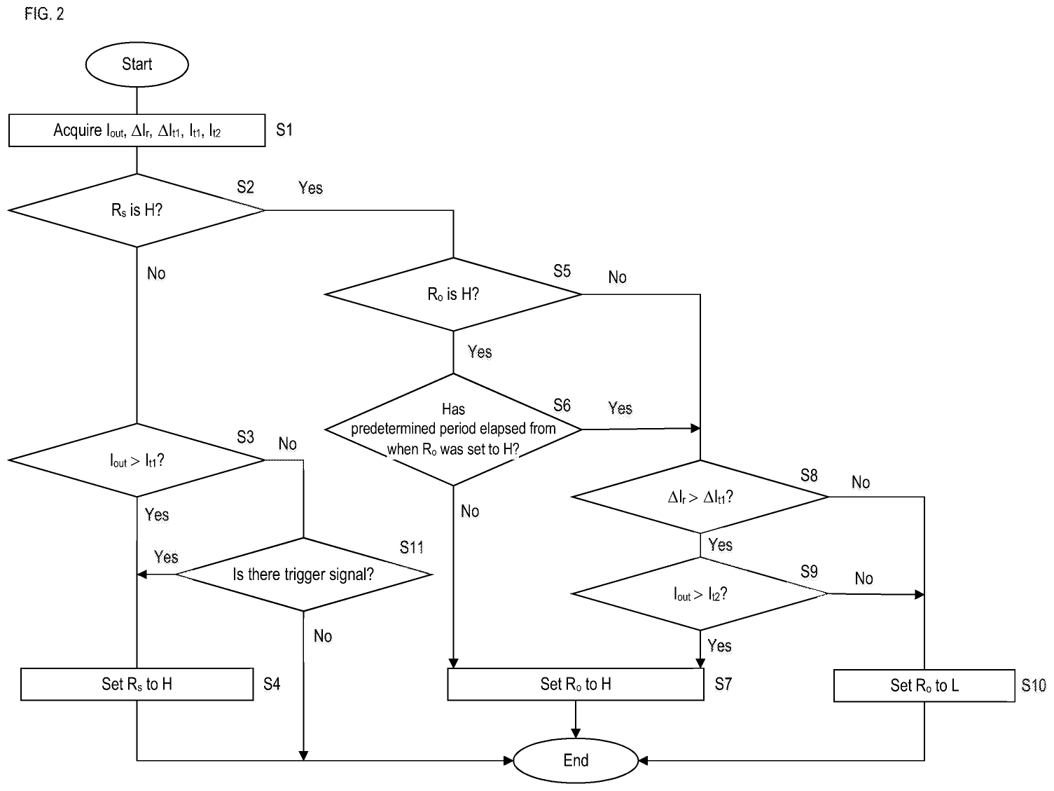

Next, operations of the processing speed determination unit 33 will be described with reference to FIG. 2, for example.

FIG. 2 illustrates determination processing that is periodic processing performed by the processing speed determination unit 33 at short intervals. The processing speed determination unit 33 starts control shown in FIG. 2 when a predetermined start condition is satisfied (for example, when a vehicle start signal (ignition signal) is switched from off to on), and thereafter the control shown in FIG. 2 is periodically executed at short intervals.

After the start of the determination processing shown in FIG. 2, the processing speed determination unit 33 first acquires a current value lout output from the current detection unit 22, a current change ratio ΔIr detected by the change ratio detection unit 32, the current change ratio threshold value ΔIt1, the low output current threshold value It1, and the high output current threshold value It2 (step S1). Note that the current change ratio threshold value ΔIt1, the low output current threshold value It1, and the high output current threshold value It2 may be stored as part of a program for executing the processing shown in FIG. 2, or may be stored in a memory or the like separately from the program and acquired in step S1.

After step S1, the processing speed determination unit 33 determines whether the wakeup signal Rs is at the high level (step S2).

If it is determined in step S2 that the wakeup signal Rs is not at the high level, the processing speed determination unit 33 determines whether the current value lout acquired based on a detection value of the current detection unit 22 is larger than the low output current threshold value It1 (step S3). If it is determined in step S3 that the current value lout is larger than the low output current threshold value It1, the processing speed determination unit 33 sets the wakeup signal Rs to the high level (step S4), then ends the determination processing shown in FIG. 2, and executes the processing again from step S1.

If it is determined in step S3 that the current value lout is equal to or smaller than the low output current threshold value It1, the processing speed determination unit 33 determines whether a trigger signal has been externally generated (step S11). If it is determined in step S11 that a trigger signal has been externally generated, the wakeup signal Rs is set to the high level (step S4), and then the determination processing shown in FIG. 2 is ended and is executed again from step S1. In contrast, if it is determined in step S11 that a trigger signal has not been externally generated, the determination processing shown in FIG. 2 is ended and is executed again from step S1.

As described above, the processing speed determination unit 33 keeps the wakeup signal Rs at the low level if the current value Iout is equal to or smaller than the low output current threshold value It1 and a predetermined trigger signal has not been externally generated, and keeps the wakeup signal Rs at the high level if the current value Tout is larger than the low output current threshold value It1 or if a trigger signal has been externally generated.

If a predetermined sleep condition is satisfied (for example, if a signal output from the power source failure detection unit 30 is switched from the non-detection signal to the failure detection signal), the processing speed determination unit 33 sets the wakeup signal Rs to the low level and the control unit 31 is switched to the sleep state. When the control unit 31 is in the sleep state, the processing speed of the control unit 31 is set to a third processing speed that is lower than a second processing speed, which will be described later. Most of the functions of the control unit 31 may be stopped when it is in the sleep state.

If it is determined in step S2 that the wakeup signal Rs is at the high level, the processing speed determination unit 33 performs processing in step S5 to determine whether the calculation-speed change request signal Ro is at the high level.

If it is determined in step S5 that the calculation-speed change request signal Ro is at the high level, the processing speed determination unit 33 performs processing in step S6 to determine whether a predetermined time period (for example, 10 ms) has elapsed from when the calculation-speed change request signal Ro was set to the high level (that is, whether the calculation-speed change request signal Ro has been kept at the high level for a time period longer than the predetermined time period).

If it is determined in step S6 that the predetermined time period has not elapsed from when the calculation-speed change request signal Ro was set to the high level, the processing speed determination unit 33 performs processing in step S7 to set the calculation-speed change request signal Ro to the high level, and ends the processing with this signal set to the high level. After step S7, the processing is executed again from step S1.

If it is determined in step S5 that the calculation-speed change request signal Ro is not at the high level or it is determined in step S6 that the predetermined time period has elapsed from when the calculation-speed change request signal Ro was set to the high level, the processing speed determination unit 33 performs processing in step S8 to determine whether the current change ratio ΔIr detected by the change ratio detection unit 32 is larger than the current change ratio threshold value ΔIt1.

If it is determined in step S8 that the current change ratio ΔIr is larger than the current change ratio threshold value ΔIt1, the processing speed determination unit 33 performs processing in step S9 to determine whether the current value Iout output from the voltage conversion unit 3 is larger than the high output current threshold value It2. If it is determined in step S9 that the current value Iout is larger than the high output current threshold value It2, the processing speed determination unit 33 performs processing in step S7 to set the calculation-speed change request signal Ro to the high level, and ends the processing with this signal set to the high level. After completion of step S7, the processing is executed again from step S1.

If it is determined in step S8 that the current change ratio ΔIr is equal to or smaller than the current change ratio threshold value ΔIt1 or it is determined in step S9 that the current value Iout is equal to or smaller than the high output current threshold value It2, the processing speed determination unit 33 performs processing in step S10 to set the calculation-speed change request signal Ro to the low level, and ends the processing with this signal set to the low level. After completion of step S10, the processing is executed again from step S1.

As described above, if the current change ratio ΔIr detected by the change ratio detection unit 32 is larger than the current change ratio threshold value ΔIt1 (first threshold value) and the current value lout of the current output from the voltage conversion unit 3 is larger than the high output current threshold value It2 (second threshold value), the processing speed determination unit 33 sets the calculation-speed change request signal Ro to the high level and makes a determination to set the processing speed to a first processing speed. In contrast, if the current change ratio ΔIr detected by the change ratio detection unit 32 is equal to or smaller than the current change ratio threshold value ΔIt1 (first threshold value) or the current value lout of the current output from the voltage conversion unit 3 is equal to or smaller than the high output current threshold value It2 (second threshold value), the processing speed determination unit 33 sets the calculation-speed change request signal Ro to the low level and makes a determination to set the processing speed to the second processing speed that is lower than the first processing speed.

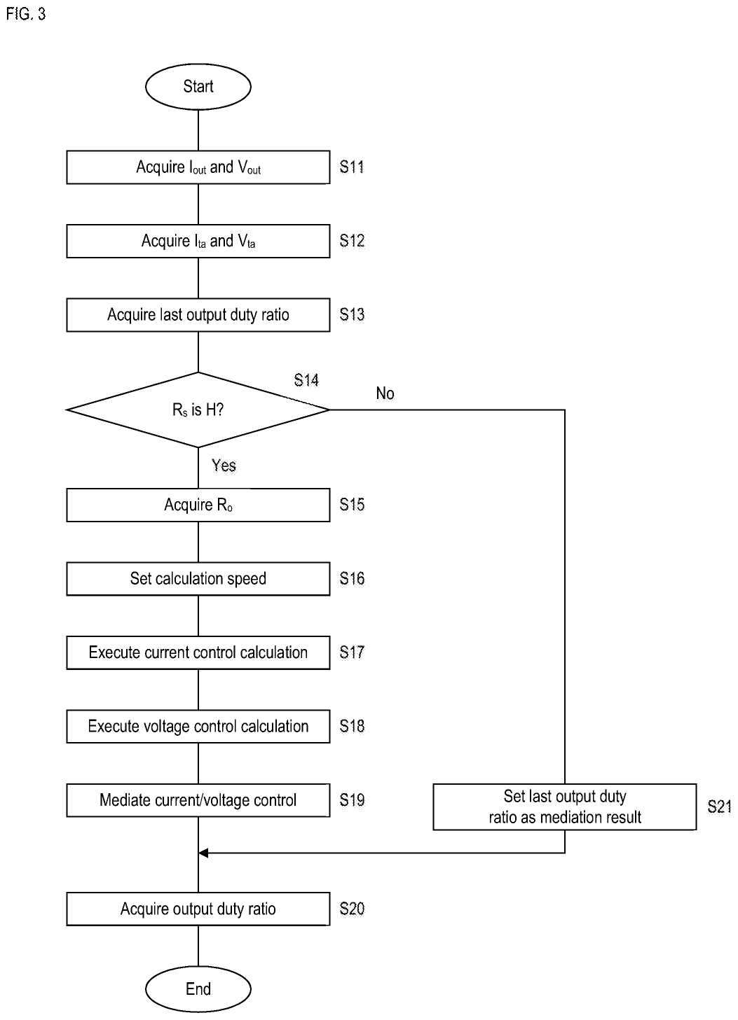

Next, feedback control executed by the control unit 31 will be described with reference to FIG. 3, for example.

The feedback control shown in FIG. 3 is executed by the control unit 31 and is processing that is periodically repeated. The control unit 31 starts the control shown in FIG. 3 when a predetermined start condition is satisfied (for example, when a vehicle start switch (for example, an ignition switch) is switched from off to on), and thereafter the control shown in FIG. 3 is periodically executed.

The control unit 31 acquires a current value lout and a voltage value Vout based on a value (detection value) input from the current detection unit 22 and a value (detection value) input from the voltage detection unit 24 (step S11). Note that some of functions of the control unit 31 are illustrated as deviation calculation units 34 and 35, the deviation calculation unit 34 acquiring the current value lout and the deviation calculation unit 35 acquiring the voltage value Vout.

After step S11, the control unit 31 acquires the target values Ita and Vta (step S12). In the example of FIG. 1, the deviation calculation unit 34 acquires the target value Ita and the deviation calculation unit 35 acquires the target value Vta.

After step S12, the control unit 31 acquires a duty ratio that was set in the last processing (that is, a duty ratio that was set in step S20 of the last processing) (step S13). For example, the duty ratio set in step S20 is stored in a memory or the like of the control unit 31 every time calculation is executed, and the control unit 31 acquires, in step S13, the last duty ratio (current duty ratio before updating) stored in the memory or the like.

After step S13, the control unit 31 determines whether the wakeup signal Rs is at the high level (step S14). Specifically, the control unit 31 determines whether the wakeup signal Rs that is output from the processing speed determination unit 33 when step S14 is executed is at the high level, and if it is determined that the wakeup signal Rs is at the high level, the control unit 31 performs processing in step S15 to acquire the calculation-speed change request signal Ro output from the processing speed determination unit 33.

After step S15, the processing speed (calculation speed) of the control unit 31 is set (step S16). Specifically, if the calculation-speed change request signal Ro that is output from the processing speed determination unit 33 when step S15 is executed is at the high level, the processing speed of the control unit 31 is set to the first processing speed (a relatively high processing speed). In this case, for example, the cycle of the feedback control in FIG. 3 (the cycle of calculating the duty ratio) performed by the control unit 31 is set to a relatively short first cycle. As a result, the processing speed of the control unit 31 is increased such that at least the feedback control is performed at shorter intervals.

In contrast, if the calculation-speed change request signal Ro that is output from the processing speed determination unit 33 when step S15 is executed is at the low level, the processing speed of the control unit 31 is set to the second processing speed (a relatively low processing speed) rather than the first processing speed. In this case, for example, the cycle of the feedback control in FIG. 3 (the cycle of calculating the duty ratio) performed by the control unit 31 is set to a relatively long second cycle. As a result, the processing speed of the control unit 31 is reduced such that at least the feedback control is performed at longer intervals.

As described above, the control unit 31 is switched between the state of the first processing speed (high-speed state), the state of the second processing speed (low-speed state), and the state of the third processing speed (sleep state). In the state of the first processing speed, the feedback control is performed at intervals that are shorter than those in the state of the second processing speed, and the period of the operation clock signal of the control unit 31 (microcomputer) is shorter (i.e., the clock frequency is higher) than that in the state of the second processing speed. The third processing speed corresponds to one example of a suppressed speed. In the state of the third processing speed, the period of the operation clock signal of the control unit 31 (microcomputer) is longer (i.e., the clock frequency is lower) than that in the state of the second processing speed.

After step S16, the control unit 31 performs processing in step S17 to acquire a deviation Di of the current value lout from the target value Ita, which is output from the deviation calculation unit 34, and determine an operation amount (the amount of an increase or a decrease in the duty ratio) for making the current value lout approach the target value Ita based on the deviation Di and preset proportional gain, differential gain, and integral gain, using a known PID calculation formula.

After step S17, the control unit 31 performs processing in step S18 in which a calculation unit 37 acquires a value Dv that corresponds to a deviation of the voltage value Vout from the target value Vta and is output from the deviation calculation unit 35, and determines an operation amount (the amount of an increase or a decrease in the duty ratio) for making the voltage value Vout approach the target value Vta based on the value Dv and preset proportional gain, differential gain, and integral gain, using a known PID calculation formula.

After step S18, the control unit 31 performs processing in step S19 in which a mediation unit 38 determines which of the operation amount determined in step S17 and the operation amount determined in step S18 is to be preferentially used (i.e., mediates between the operation amounts). Various methods can be employed to determine the operation amount to be preferentially used. For example, a smaller operation amount (an operation amount that makes the duty ratio smaller) may be preferentially used out of the operation amounts respectively determined by calculation units 36 and 37. Note that the determination method is not limited to this method, and any other known method may be employed.

If it is determined in step S14 that the wakeup signal Rs output from the processing speed determination unit 33 is not at the high level, the control unit 31 performs processing in step S21 to keep the duty ratio set in the last feedback control. That is, if the control unit 31 performs the processing in step S21, the last duty ratio is kept without being updated and is used as a mediation result.

After step S19 or step S21, the control unit 31 performs step S20 to set the duty ratio based on the result of processing in step S19 or step S21. If step S20 is performed after step S19, the mediation unit 38 adds the operation amount determined in step S19 to the last duty ratio and sets the resultant value as a new duty ratio. If step S20 is performed after step S21, the mediation unit 38 sets the last duty ratio as a new duty ratio. When the new duty ratio is set in step S20, the mediation unit 38 continues to output a PWM signal of this duty ratio to the voltage conversion unit 3 at least until the processing in step S20 is performed the next time. Note that after setting the duty ratio in step S20, the control unit 31 performs calculation again from step S11.

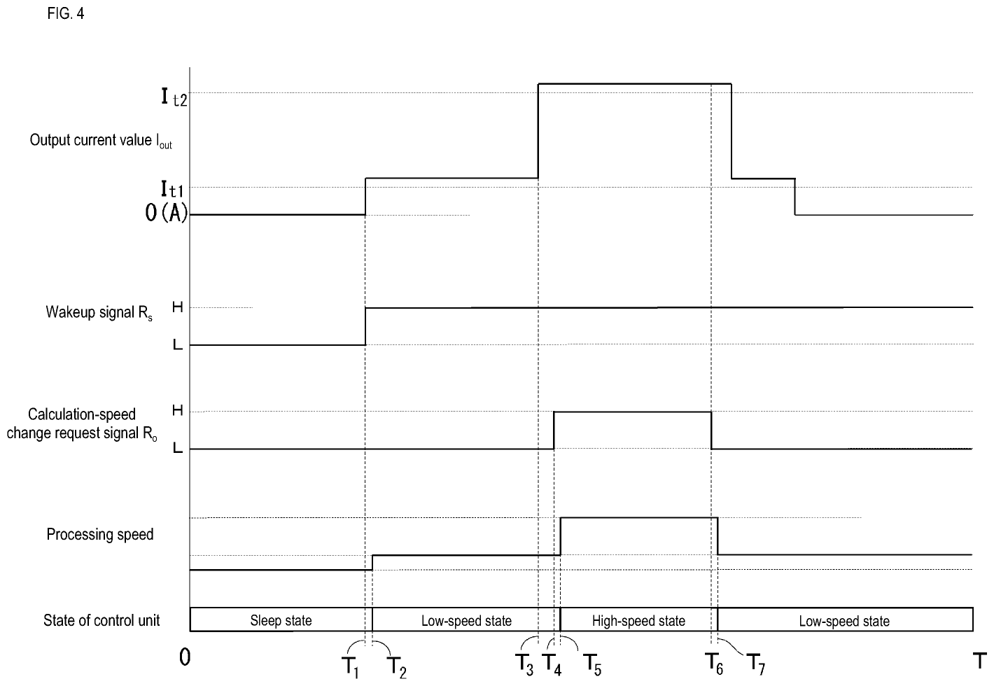

Next, the following describes an example of changes in the current value lout and accompanying changes in the wakeup signal Rs, the calculation-speed change request signal Ro, the processing speed of the control unit 31, and the state of the control unit 31, mainly with reference to FIG. 4. Note that FIG. 4 illustrates a case where a trigger signal is not externally generated.

In the example shown in FIG. 4, the control unit 31 is kept in the sleep state when the output current value lout of the voltage conversion unit 3 is smaller than the low output current threshold value It1. In the example shown in FIG. 4, the output current value lout changes in the sleep state as a result of a load change or the like, and exceeds the low output current threshold value It1 at time T1. Therefore, the processing speed determination unit 33 makes a positive determination in step S3 in FIG. 2 almost at the same time as time T1, and switches the wakeup signal Rs from the low level to the high level (step S4 in FIG. 2). When the wakeup signal Rs is switched to the high level by the processing speed determination unit 33 as described above, the control unit 31 enters a predetermined low-speed state from the sleep state at time T2 right after the switching. As a result, the processing speed of the control unit 31 becomes higher than that in the sleep state.

Note that the sleep state may be a state in which the operation clock signal of the control unit 31 is not generated or a state in which the period of the operation clock signal of the control unit 31 is long, for example. The low-speed state may be a state in which some functions of the control unit 31 are stopped, a state in which the period of the operation clock signal of the control unit 31 is longer (i.e., the clock frequency (operation frequency) is lower) than that in a high-speed state described later, or a state in which both are true. The power consumption of the control unit 31 corresponds to the processing speed, and is higher in the low-speed state than in the sleep state.

When the control unit 31 is in the sleep state, an operation clock signal is stopped or an operation clock signal with a period that is set to a third period is generated. When the control unit 31 is in the low-speed state, an operation clock signal with a period that is set to a second period is generated. If the operation clock signal with the third period is generated when the control unit 31 is in the sleep state, the second period is shorter than the third period. Further, the execution cycle (calculation cycle) of the feedback control in FIG. 3 performed by the control unit 31 is shorter in the low-speed state than in the sleep state. In the example shown in FIG. 4, after the control unit 31 enters the low-speed state from the sleep state at time T2, the current value lout sharply changes around time T3. In a period around time T3 in which such a change occurs, the current change ratio ΔIr becomes larger than the current change ratio threshold value ΔIt1, and the current value lout becomes larger than the high output current threshold value It2. As a result of these changes, the processing speed determination unit 33 makes positive determinations in step S8 and step S9 of the periodic processing shown in FIG. 2, and switches the calculation-speed change request signal Ro from the low level to the high level at time T4 based on these determinations. When the calculation-speed change request signal Ro is switched to the high level by the processing speed determination unit 33 as described above, the control unit 31 enters a predetermined high-speed state from the low-speed state at time T5 right after the switching. As a result, the processing speed of the control unit 31 becomes higher than that in the low-speed state.

When the control unit 31 is in the low-speed state, an operation clock signal with a period that is set to the second period is generated, and when the control unit 31 is in the high-speed state, an operation clock signal with a period that is set to a first period is generated. The first period is shorter than the second period. Further, the execution cycle (calculation cycle) of the feedback control in FIG. 3 performed by the control unit 31 is shorter in the high-speed state than in the low-speed state.

In the example shown in FIG. 4, after the control unit 31 enters the high-speed state from the low-speed state at time T5, a condition for switching the control unit from the high-speed state to the low-speed state is satisfied (i.e., a predetermined time period has elapsed from when the calculation-speed change request signal Ro was switched to the high level and ΔIr≤ΔIt1 or Iout≤It2 is satisfied) at time T6, and the calculation-speed change request signal Ro is switched to the low level. When the calculation-speed change request signal Ro is switched to the low level by the processing speed determination unit 33 as described above, the control unit 31 enters the low-speed state from the high-speed state at time T7 right after the switching. As a result, the processing speed of the control unit 31 becomes lower than that in the high-speed state.

Although the example shown in FIG. 4 has been described regarding a case where a trigger signal is not externally generated, switching from the sleep state to a wakeup state can also be performed when a trigger signal is externally generated. For example, if any of the above-described trigger signals is given to the processing speed determination unit 33 in the sleep state shown in FIG. 4, switching to the low-speed state shown in FIG. 4 is performed. Specifically, switching to the low-speed state shown in FIG. 4 is performed when, in the sleep state, the processing speed determination unit 33 receives a signal indicating that the speed of the vehicle is equal to or lower than a predetermined speed from the vehicle speed sensor 102, or receives a signal indicating a shift operation to the P range from the shift-by-wire ECU 104.

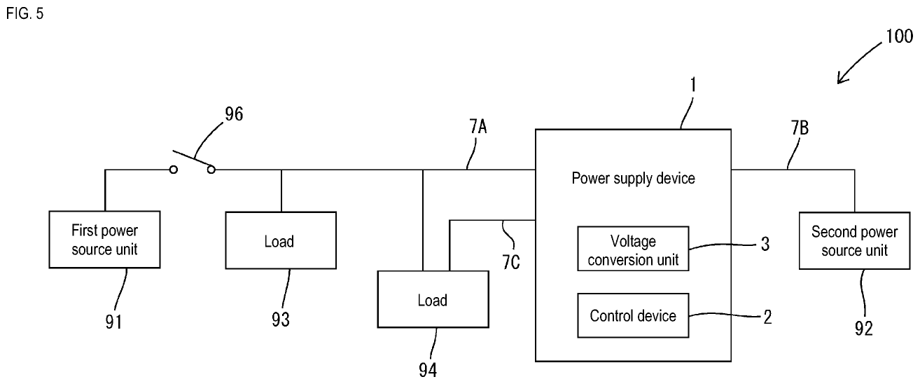

The above-described power supply device 1 is effective when it is applied to an onboard power supply system 100 shown in FIG. 5. In the system shown in FIG. 5, the first power source unit 91 is configured as a main power source such as a lead battery, and loads 93 and 94 are connected to the first power source unit 91. The load 93 is a load (for example, the shift-by-wire ECU 104) that is capable of generating the above-described trigger signal. The load 94 is a load (for example, an electric parking brake device) that is desired to receive power supply even when a failure has occurred in the first power source unit 91. Note that the generator 97 shown in FIG. 1 is also electrically connected to the first power source unit 91 though this is not shown in FIG. 5. A direct current voltage is applied to the conductive path 7A from the first power source unit 91 (main power source). On the other hand, the second power source unit 92 is configured as a sub power source such as an electric double layer capacitor or a lithium ion battery, and a direct current voltage is applied to the conductive path 7B from the second power source unit 92 (sub power source). For example, the output voltage of the first power source unit 91 (main power source) when it is fully charged is larger than the output voltage of the second power source unit 92 (sub power source) when it is fully charged, and the power supply device 1 is capable of performing a step-down operation of stepping down the direct current voltage applied to the conductive path 7A and outputting the resultant voltage to the conductive path 7B, and a step-up operation of stepping up the direct current voltage applied to the conductive path 7B and outputting the resultant voltage to the conductive path 7A or a conductive path 7C. In the step-up operation, the voltage that is stepped up by the voltage conversion unit 3 may be applied to both the conductive path 7A and the conductive path 7C, or may be applied to only one of the conductive path 7A and the conductive path 7C.

Further, a switching unit 96 is provided between the first power source unit 91 (main power source) and the power supply device 1, and upon occurrence of a specific situation (for example, a failure in the main power source or a ground fault on the main power source side), the first power source unit 91 (main power source) and the power supply device 1 can be electrically disconnected from each other by switching off the switching unit 96. Further, even when the switching unit 96 is switched off, power can be supplied to the load 94 or the like from the second power source unit 92 (sub power source) while the power supply device 1 is performing the step-up operation.

In the above-described onboard power supply system 100, if the specific situation (for example, a ground fault on the main power source side) has occurred and the switching unit 96 is switched off, the load 94 or the like needs to be operated using power supplied from the second power source unit 92 (sub power source), and therefore power consumption of the power supply device 1 needs to be suppressed to the minimum. In this regard, the application of the power supply device 1 of the present embodiment to such a system is advantageous because the power supply device 1 is capable of suppressing the power consumption as described above. Further, if the first power source unit 91 (main power source) and the power supply device 1 are electrically disconnected from each other and the load 94 or the like is operated using power from the second power source unit 92 (sub power source), there is a concern that output may become unstable as a result of a load change. However, the above-described power supply device 1 is also advantageous in this regard because measures are taken to stabilize output.

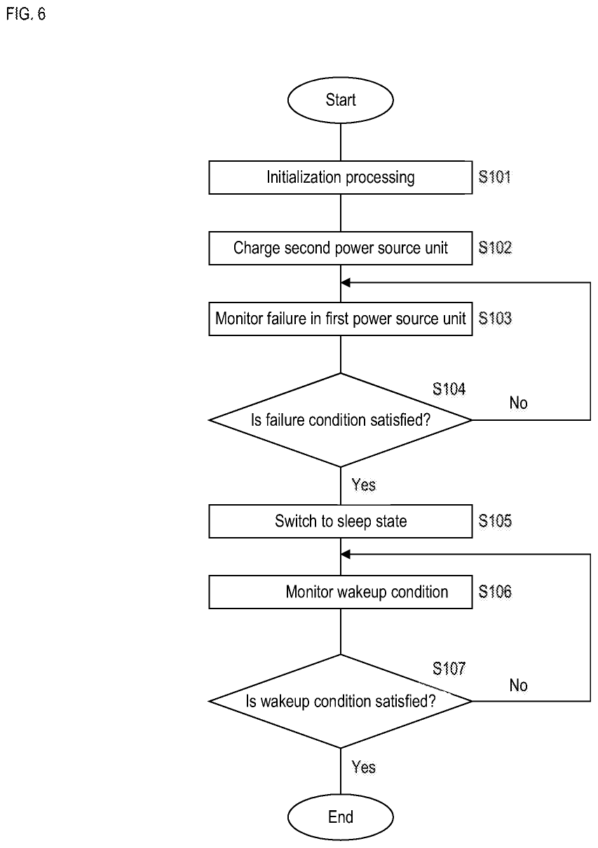

In this configuration, the control device 2 can perform control as shown in FIG. 6, for example. The control shown in FIG. 6 is executed by the control device 2 at a predetermined time (for example, when a start switch (ignition switch or the like) is switched from off to on). First, predetermined initialization processing is performed in step S101, and thereafter charging of the second power source unit 92 is started in step S102. The charging is performed using power supplied from the first power source unit 91 or the generator 97. When the charging is started in step S102, the control unit 31 causes the voltage conversion unit 3 to operate in the step-down mode, and the step-down operation is performed by stepping down a direct current voltage applied to the conductive path 7A and outputting the resultant voltage to the conductive path 7B to charge the second power source unit 92 (sub power source) using power from the first power source unit 91 (main power source) or the generator 97. For example, if the charging is performed while the generator 97 is stopped, an output voltage of the first power source unit 91 (main power source) is used as input and the voltage conversion unit 3 is caused to perform the operation in the step-down mode (specifically, the step-down operation in which an on/off operation of the switching element is performed according to a PWM signal) to apply a desired voltage to the conductive path 7B and charge the second power source unit 92 (sub power source). Alternatively, if the output voltage of the generator 97 is higher than the charged voltage of the first power source unit 91, the second power source unit 92 (sub power source) can be charged by using the output voltage of the generator 97 as input and causing the voltage conversion unit 3 to perform the operation in the step-down mode (specifically, the step-down operation in which an on/off operation of the switching element is performed according to a PWM signal) to apply a desired voltage to the conductive path 7B. If the output of the generator 97 and the output of the first power source unit 91 are equivalent to each other, the second power source unit 92 (sub power source) is charged using power from the generator 97 and the first power source unit 91. Note that the control unit 31 charges the second power source unit 92 until the output voltage (charged voltage) of the second power source unit 92 reaches a predetermined target voltage.

After the charging of the second power source unit 92 is started in step S102 or the charging of the second power source unit 92 is completed, the processing speed determination unit 33 monitors for occurrence of a failure in the first power source unit 91 (step S103). The monitoring of occurrence of a failure in the first power source unit 91 in step S103 is continued until a failure condition regarding the first power source unit 91 is satisfied. Specifically, the processing speed determination unit 33 determines, in step S104, whether a failure detection signal has been output from the power source failure detection unit 30 (i.e., whether a voltage applied to the first conductive path 7A is lower than a predetermined threshold value), and if the failure detection signal has not been output from the power source failure detection unit 30, determines that the failure condition regarding the first power source unit 91 is not satisfied and returns to step S103 and continues monitoring the failure state of the first power source unit 91 (monitoring a signal from the power source failure detection unit 30). In contrast, if the failure detection signal has been output from the power source failure detection unit 30, the processing speed determination unit 33 determines, in step S104, that the failure condition regarding the first power source unit 91 is satisfied, and proceeds to step S105 and switches the wakeup signal Rs to the low level to cause the control unit 31 to enter the sleep state. As described above, if a failure has occurred in the first power source unit 91, the control unit 31 is switched to the sleep state to suppress the power consumption.

After switching the wakeup signal Rs to the low level and switching the control unit 31 to the sleep state in step S105, the processing speed determination unit 33 monitors a wakeup condition in step S106. The monitoring of the wakeup condition in step S106 is continued until the wakeup condition is satisfied. The wakeup condition is a condition for switching the wakeup signal Rs from the low level to the high level, and is satisfied if the above-described predetermined trigger signal (a signal output from the vehicle sensor 102 indicating that the speed of the vehicle is equal to or lower than a predetermined speed or a signal output from the shift-by-wire ECU 104 indicating a shift operation to the P range) is input to the processing speed determination unit 33 or the current value Tout becomes larger than the low output current threshold value It1. If the wakeup condition is satisfied, the processing speed determination unit 33 makes a positive determination in step S107 and ends the control shown in FIG. 6.

A state in which a negative determination is repeated in step S107 of the control shown in FIG. 6 corresponds to a state in which a negative determination is repeated in step S11 of the repeatedly performed control shown in FIG. 2. Also, the determination in step S107 corresponds to the determinations in step S3 and step S11 in FIG. 2, and a case where a positive determination is made in step S107 corresponds to a case where a positive determination is made in step S3 or step S11 in FIG. 2.

Note that the control shown in FIG. 6 may be forcibly ended when a predetermined ending condition is satisfied (for example, when the start switch (ignition switch or the like) is switched off).

In the onboard control device 2 of the present embodiment, the processing speed determination unit 33 sets the processing speed to a relatively low suppressed speed (third processing speed) at least when the failure state of the first power source unit 91 is detected by the power source failure detection unit 30. Further, the control unit 31 performs feedback control on the voltage conversion unit 3 while operating at the processing speed determined by the processing speed determination unit 33. As described above, after the occurrence of a failure in the first power source unit 91, the control unit 31 operates at the suppressed speed and therefore the consumption of power supplied from the second power source unit 92 can be suppressed. On the other hand, if a trigger signal is externally generated while the processing speed is set to the suppressed speed, the processing speed determination unit sets the processing speed to a speed (second processing speed) higher than the suppressed speed. As described above, if the trigger signal is externally generated, the processing speed is switched to enable the control unit 31 to operate at a relatively high processing speed. Thus, once the trigger signal is generated, restrictions are alleviated and the power supply can be increased.

In the present embodiment, a signal indicating that the speed of the vehicle in which the onboard control device 2 is installed is equal to or lower than a predetermined speed serves as the trigger signal. If the signal indicating that the speed of the vehicle is equal to or lower than the predetermined speed is externally generated while the processing speed is set to the suppressed speed (third processing speed), the processing speed determination unit 33 sets the processing speed to a speed higher than the suppressed speed. The onboard control device 2 configured as described above is capable of immediately suppressing power consumption upon the occurrence of a failure in the first power source unit 91, and thereafter increasing the power supply by alleviating restrictions when the speed of the vehicle becomes equal to or lower than the predetermined speed. That is, the consumption of power of the second power source unit 92 is restricted until the speed of the vehicle becomes equal to or lower than the predetermined speed, and therefore the power of the second power source unit can be easily secured after the speed of the vehicle becomes equal to or lower than the predetermined speed. This makes it easier for apparatuses to properly perform operations that are to be performed when the speed of the vehicle is equal to or lower than the predetermined speed (for example, the shift operation to the P range or an operation of the electric parking brake).

In the present embodiment, a signal indicating that a predetermined shift operation has been performed by the user serves as the trigger signal. If the signal indicating that the predetermined shift operation has been performed is externally generated while the processing speed is set to the suppressed speed (third processing speed), the processing speed determination unit 33 sets the processing speed to a speed (second processing speed) higher than the suppressed speed. The onboard control device 2 configured as described above is capable of immediately suppressing power consumption upon the occurrence of a failure in the first power source unit 91, and thereafter increasing the power supply by alleviating restrictions when the predetermined shift operation is performed. That is, the consumption of power of the second power source unit 92 is restricted until the predetermined shift operation is performed, and therefore the power of the second power source unit 92 can be easily secured when the predetermined shift operation is performed. This makes it easier for apparatuses to properly perform operations that are to be performed after the predetermined shift operation (for example, an operation of an actuator for shift switching or an operation of the electric parking brake).

### Other Embodiments

The present disclosure is not limited to the first embodiment described above with reference to the drawings, and the following embodiments are also included in the technical scope of the present disclosure, for example.

Although the voltage detection unit and the current detection unit are provided on the second conductive path 7B in the first embodiment, the voltage detection unit and the current detection unit may be provided on the first conductive path 7A.

Although the wakeup signal and the calculation-speed change request signal are switched by a hardware circuit (processing speed determination unit 33) that is different from the control unit 31 in the first embodiment, the control unit 31 may have the function of switching these signals.

Although the first embodiment is described regarding a case where the control unit 31 is constituted by a microcomputer, the control unit 31 may be constituted by a hardware circuit other than the microcomputer.

The first embodiment is described regarding a case where the range of the change ratio ΔIr of the output current is divided into two ranges, that is, a range of values that are larger than the current change ratio threshold value ΔIt1 and a range of values that are equal to or smaller than ΔIt1, and the processing speed of the control unit 31 is switched between two stages, that is, the low-speed state and the high-speed state, according to which of the two ranges the change ratio belongs. However, the range of the change ratio of the output current may be divided into three or more ranges, and the processing speed of the control unit 31 may be switched between three or more stages according to which of the ranges the change ratio belongs, such that the processing speed increases as the change ratio increases. For example, the following configuration may be employed. If the change ratio ΔIr is in a first range and the output current is larger than the high output current threshold value, the period of the operation clock signal of the control unit 31 is set to a first period and the cycle of the feedback calculation shown in FIG. 3 is set to a first setting. If the change ratio ΔIr is in a second range (a range of values smaller than those of the first range) and the output current is larger than the high output current threshold value, the period of the operation clock signal of the control unit 31 is set to a second period (a period longer than the first period) and the cycle of the feedback calculation shown in FIG. 3 is set to a second setting (a cycle longer than the first setting). If the change ratio ΔIr is in a third range (a range of values smaller than those of the second range) or the output current is equal to or smaller than the high output current threshold value, the period of the operation clock signal of the control unit 31 is set to a third period (a period longer than the second period) and the cycle of the feedback calculation shown in FIG. 3 is set to a third setting (a cycle longer than the second setting).

In the first embodiment, the processing speed of the control unit 31 is set to the above-described first processing speed if the change ratio ΔIr detected by the change ratio detection unit 32 is larger than the predetermined first threshold value and the current value Iout of the current output from the voltage conversion unit 3 is larger than the predetermined second threshold value. However, for example, processing in step S9 in FIG. 2 may be omitted, and the processing speed of the control unit 31 may be set to the above-described first processing speed if the change ratio ΔIr detected by the change ratio detection unit 32 is larger than the predetermined first threshold value, and the processing speed of the control unit 31 may be set to the above-described second processing speed if the change ratio ΔIr detected by the change ratio detection unit 32 is equal to or smaller than the predetermined first threshold value.

In the first embodiment, when the processing speed of the control unit 31 (microcomputer) is that of the low-speed state, the clock frequency (operation frequency) is 0.1 kHz to 1 kHz, for example. However, this is no limitation and the clock frequency in the low-speed state may be lower than 0.1 kHz or higher than 1 kHz.

In the first embodiment, when the processing speed of the control unit 31 (microcomputer) is that of the high-speed state, the clock frequency (operation frequency) is 10 kHz to 50 kHz, for example. However, this is no limitation and the clock frequency in the high-speed state may be lower than 10 kHz or higher than 50 kHz.

Although the predetermined time period used in step S6 in FIG. 2 is 10 ms in the first embodiment, the predetermined time period may be longer or shorter than 10 ms.

1. An onboard control device in an onboard power supply system that includes a first power source unit, a second power source unit, and a voltage conversion unit that is capable of performing a discharging operation of stepping up or stepping down an input voltage based on power supply from the second power source unit and outputting a resultant voltage through an on/off operation of a switching element according to a PWM signal, the onboard power supply system being capable of charging the second power source unit using power supplied from the first power source unit or a generator, the onboard control device being configured to control the discharging operation of the voltage conversion unit and comprising:
a power source failure detection unit that detects a predetermined failure state of power supply from the first power source unit;
a processing speed determination unit that sets a processing speed to a predetermined suppressed speed at least when the failure state is detected by the power source failure detection unit, and sets the processing speed to a speed higher than the suppressed speed when a trigger signal is externally generated while the processing speed is set to the suppressed speed; and
a control unit that is configured to operate at a processing speed determined by the processing speed determination unit, and performs feedback control by calculating a duty ratio of a PWM signal to be given to the voltage conversion unit based on a preset target value and an output value from the voltage conversion unit, and outputting a PWM signal set to the calculated duty ratio to the voltage conversion unit.

2. The onboard control device according to claim 1,
wherein the trigger signal is a signal that indicates that a speed of a vehicle in which the onboard control device is installed is equal to or lower than a predetermined speed, and
the processing speed determination unit sets the processing speed to a speed higher than the suppressed speed when the signal indicating that the speed of the vehicle is equal to or lower than the predetermined speed is externally generated while the processing speed is set to the suppressed speed.

3. The onboard control device according to claim 1,
wherein the trigger signal is a signal that indicates that a predetermined shift operation has been performed by a user, and
the processing speed determination unit sets the processing speed to a speed higher than the suppressed speed when the signal indicating that the predetermined shift operation has been performed is externally generated while the processing speed is set to the suppressed speed.

4. An onboard power supply device comprising:
the onboard control device according to claim 1; and the voltage conversion unit.

5. An onboard power supply device comprising:
the onboard control device according to claim 2; and
the voltage conversion unit.

6. An onboard power supply device comprising:
the onboard control device according to claim 3; and
the voltage conversion unit.
